(19) United States
(12) Patent Application Publication
(10) Pub. No.: US 2013/0051811 A1
(43) Pub. Date: Feb. 28, 2013

(54) IMAGE FORMING APPARATUS

(71) Applicant: Tomomichi Kawashima, Numazu-shi (JP)

(72) Inventor: Tomomichi Kawashima, Numazu-shi (JP)

(73) Assignee: CANON KABUSHIKI KAISHA, Tokyo (JP)

(21) Appl. No.: 13/592,234

(22) Filed: Aug. 22, 2012

(30) Foreign Application Priority Data
Aug. 31, 2011 (JP) 2011-188960

(51) Int. Cl. G03G 15/08

(52) U.S. Cl. 399/12; 399/53

(57) ABSTRACT

An image forming apparatus includes a motor configured to drive a developing roller and a stirring member and a motor configured to drive a photosensitive drum. When initial driving of the stirring member of a new process cartridge is performed, the image forming apparatus drives the photosensitive drum at a peripheral velocity higher than that at the time of image formation to aid the rotation of the developing roller.

### BACKGROUND OF THE INVENTION

1. Field of the Invention

The present invention relates to an electrophotographic type image forming apparatus such as a copying machine and a printer equipped with a process cartridge detachable with respect to the apparatus main body thereof.

2. Description of the Related Art

Conventionally, an electrophotographic type image forming apparatus has adopted a process cartridge system in which a photosensitive drum and a process unit acting on the photosensitive drum are integrally combined into a cartridge that is detachable with respect to the image forming apparatus main body. In the process cartridge system, an operator can perform maintenance of the apparatus by himself/herself without relying on a serviceperson, thus the operability can be substantially improved. Therefore, the process cartridge system is widely employed for electrophotographic type image forming apparatuses.

In order to apply a toner to an electrostatic latent image formed on the photosensitive drum, the process cartridge employs a developing device. An example of the developing device includes a toner container for storing a toner, a developing roller provided at an opening of the toner container and configured to supply the toner to the photosensitive drum, and a regulating member configured to regulate an amount of developer on the developing roller.

There is commonly known a phenomenon in which, due to vibration provided to the process cartridge during transportation or the like, the toner in the toner container is coagulated. Due to the influence of this phenomenon, when a toner in a toner container is stirred for the first time in a new process cartridge, load torque for driving a stirring member may become larger than that at the time of image formation.

Thus, in the conventional image forming apparatus, specifications of a driving device such as a motor for driving the stirring member is to be larger than that used at the time of image formation taking into account a case where the toner is coagulated in a new process cartridge.

Japanese Patent Application Laid-Open No. 2003-307932 discusses an image forming apparatus in which when it is determined that a motor for driving a stirring member is not normally rotating during the driving of the stirring member, it is determined that a toner has been coagulated, and the coagulation of the toner is eliminated by slowing down the rotational speed of the motor.

However, in the image forming apparatus discussed in Japanese Patent Application Laid-Open No. 2003-307932, when the toner is coagulated, the motor is rotated at a lower speed than during image formation, so that it takes a rather long time before the image formation at the start of use of the cartridge, which means there is a fear of increase in the waiting time for the user.

### SUMMARY OF THE INVENTION

The present invention is directed to an image forming apparatus which can eliminate toner coagulation by a simple configuration while suppressing increase in waiting time for a user at the start of use of a process cartridge.

According to an aspect of the present invention, an image forming apparatus includes a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container, a first driving device configured to drive the developer carrying member and the stirring member, a second driving device configured to drive the image bearing member, and a control unit configured to drive the developer carrying member and the stirring member by the first driving device and to execute an operation for driving the image bearing member by the second driving device at a peripheral velocity higher than that at a time of image formation before image formation is first performed by using a new process cartridge.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a main portion sectional view illustrating an image forming apparatus according to an exemplary embodiment of the present invention.

FIG. 2 is a main portion sectional view illustrating a process cartridge according to the exemplary embodiment of the present invention.

FIG. 3 is a main portion perspective view illustrating the image forming apparatus according to the exemplary embodiment of the present invention.

FIG. 4 is a main portion perspective view illustrating the image forming apparatus according to the exemplary embodiment of the present invention.

FIG. 5 is a flowchart illustrating processing according to the exemplary embodiment of the present invention.

FIG. 6 illustrates a torque reduction effect according to the present invention.

FIG. 7 is a main portion perspective view illustrating a process cartridge according to a second exemplary embodiment of the present invention.

### DESCRIPTION OF THE EMBODIMENTS

Various exemplary embodiments, features, and aspects of the invention will be described in detail below with reference to the drawings.

A first exemplary embodiment according to the present invention will be described in detail below with reference to the drawings. The dimensions, materials, configurations, and positional relationship of the components described in relation to the exemplary embodiment allow modifications as appropriate according to the apparatus to which the present invention is applied and to various conditions, so that, unless otherwise specified, they are not to be construed as intended to restrict the scope of the present invention.

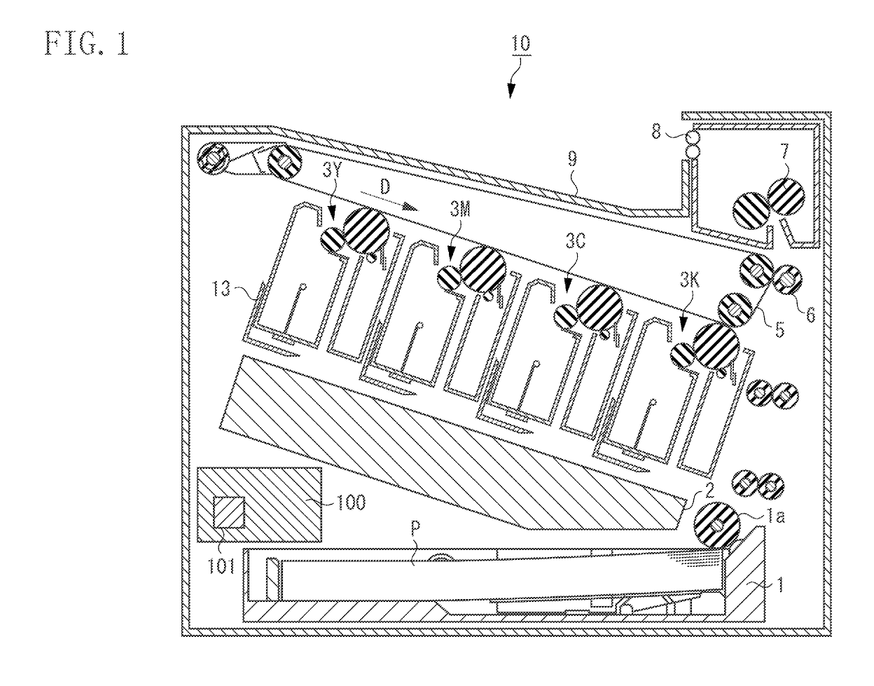

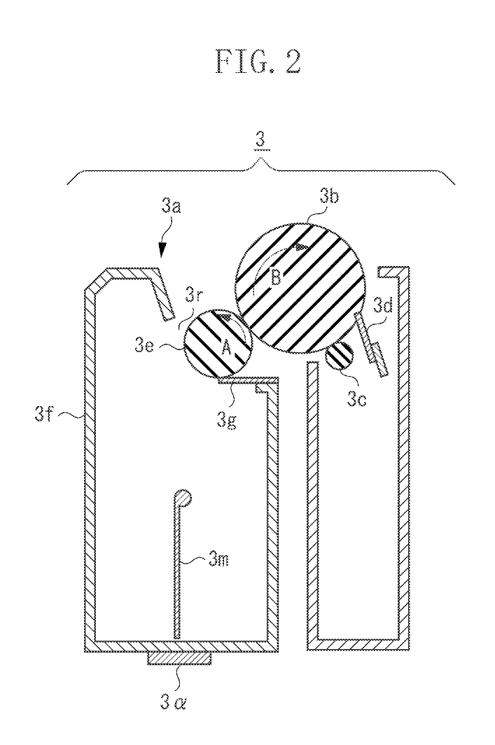

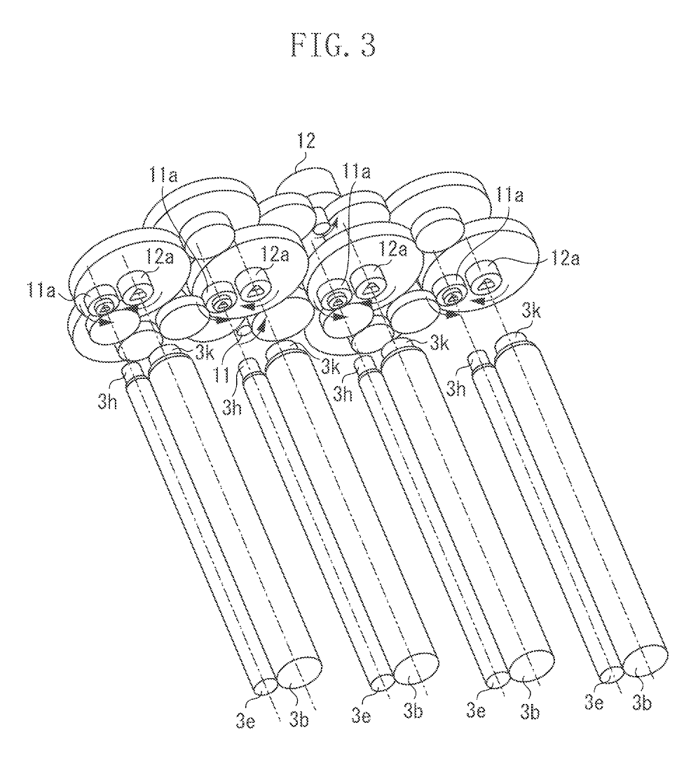

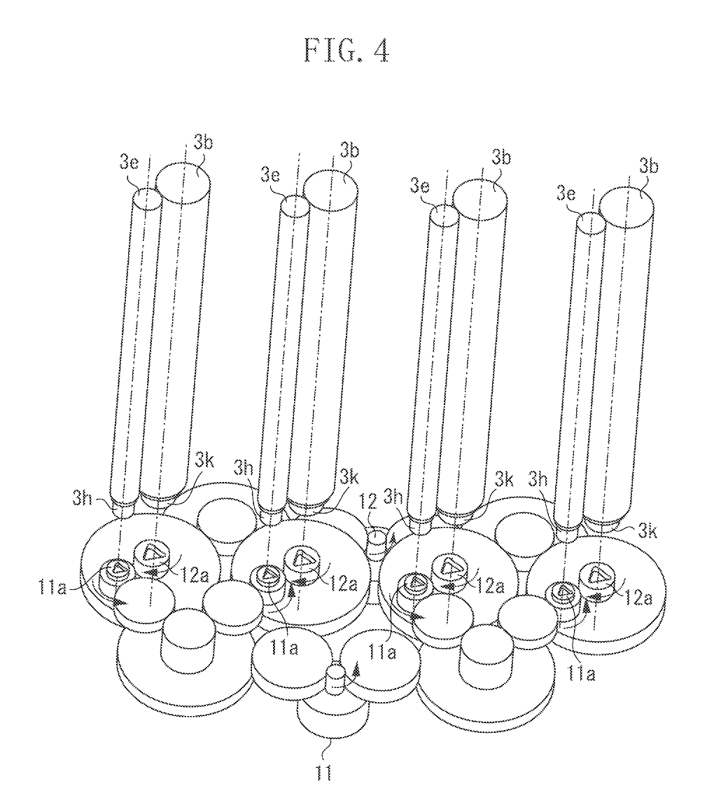

FIG. 1 is a sectional view schematically illustrating a configuration of an image forming apparatus according to the present exemplary embodiment. FIG. 2 is a sectional view schematically illustrating a configuration of a process cartridge according to the present exemplary embodiment. FIGS. 3 and 4 are perspective views schematically illustrating the configuration of the image forming apparatus according to the present exemplary embodiment.

The image processing apparatus is an apparatus configured to form a toner image by using a toner as a developer based on externally input image information and transfer and fix the toner image to a medium such as paper by the known electrophotographic technique. Examples of the image processing apparatus include a laser beam printer, a facsimile apparatus, and the like. By way of example, the present exemplary embodiment will be described as applied to a color laser beam printer including a plurality of process cartridges to form a color image.

The process cartridge is defined as a cartridge into which at least a developing device and an electrophotographic image bearing member (photosensitive drum) as process units are integrated and which is detachable with respect to the main body of an image forming apparatus.

First, the configuration and function of an image forming apparatus 10 will be described with reference to FIGS. 1 and 2. The image forming apparatus 10 includes a feeding device 1, an exposure unit 2, a process cartridge 3, an intermediate transfer member 5, a primary transfer unit (not illustrated), a secondary transfer unit 6, and a fixing unit 7.

A toner image formed on a surface of a photosensitive drum 3b (image bearing member) of the process cartridge 3 by a process unit described below is transferred to a surface of the intermediate transfer member 5 by the primary transfer unit (not illustrated).

FIG. 1 illustrates a tandem type color image forming apparatus in which four process cartridges 3Y, 3M, 3C, and 3K are arranged in a straight line.

The four process cartridges 3Y, 3M, 3C, and 3K, which are of the same structure, respectively correspond to the four colors of yellow (Y), magenta (M), cyan (C), and black (K), and are configured to form toner images of the respective colors on the intermediate transfer member 5 rotating in the direction indicated by an arrow D so as to superimpose them one upon the other.

A medium P such as paper set in the feeding device 1 is fed to the secondary transfer unit 6 by a feeding roller 1a. The toner image formed on the intermediate transfer member 5 is transferred to the medium P by the secondary transfer unit 6, and is conveyed to the fixing unit 7, where the toner image is fixed to the medium P by heat and pressure. Then, the medium P is conveyed by a discharge roller pair 8a and 8b and is discharged onto a discharge tray 9 provided in the upper portion of the image forming apparatus 10.

As illustrated in FIGS. 3 and 4, the image forming apparatus 10 include a motor 11 (first driving device) and a motor 12 (second driving device) as the driving devices for operating the process cartridges 3Y, 3M, 3C, and 3K.

As illustrated in FIG. 1, the image forming apparatus 10 is provided with a control circuit board 100 on which there is mounted an electric circuit for controlling the main body of the image forming apparatus 10. A central processing unit (CPU) 101 is mounted on the control circuit board 100. The CPU 101 collectively controls operations of the main body of the image forming apparatus 10, inclusive of the control of the motor 11 and the motor 12, which are the driving devices for the process cartridges 3. The CPU 101 can perform wireless communication with a non-contact type nonvolatile memory 3α (See FIG. 2) serving as a storage device mounted to the process cartridges 3, and write and read information to and from the non-contact type nonvolatile memory 3α as described below. The main body of the image forming apparatus 10 includes an attachment portion 13 for detachably attaching the process cartridge 3.

Next, the configuration and function of the process cartridge 3 detachably mounted to the image forming apparatus 10 will be described with reference to FIGS. 1 through 4. Each of the process cartridges 3 includes a developing device 3a, a photosensitive drum 3b, a charging roller 3c as a charging unit, and a cleaning blade 3d as a cleaning unit. The developing device 3a includes a developing roller 3e, a toner container 3f (developer container), a regulating member 3g, a stirring member 3m, and non-contact type nonvolatile memory 26.

The photosensitive drum 3b is provided so as to be rotatable. The charging roller 3c, the developing roller 3e, and the cleaning blade 3d are arranged around the photosensitive drum 3b, and each are in contact with the photosensitive drum 3b. (The developing roller 3e is arranged so as to pressurize the photosensitive drum 3b via the toner). The photosensitive drum 3b charged by the charging roller 3c is irradiated with a laser beam corresponding to image information from an exposure unit 2, so that an electrostatic latent image is formed. The electrostatic latent image is developed with the toner by the developing roller 3e arranged so as to be in contact with the photosensitive drum 3b, and is turned into a visible image, i.e., a toner image.

The cleaning blade 3d scrapes off the residual toner remaining on the photosensitive drum 3b after the toner image has been transferred to the intermediate transfer member 5 by the primary transfer unit (not illustrated), thus cleaning the surface of the photosensitive drum 3b.

The developing roller 3e is arranged at an opening 3r of the toner container 3f for storing the toner. The regulating member 3g is arranged to be in contact with the developing roller 3e and regulates a toner amount to be carried as a thin layer on the developing roller 3e.

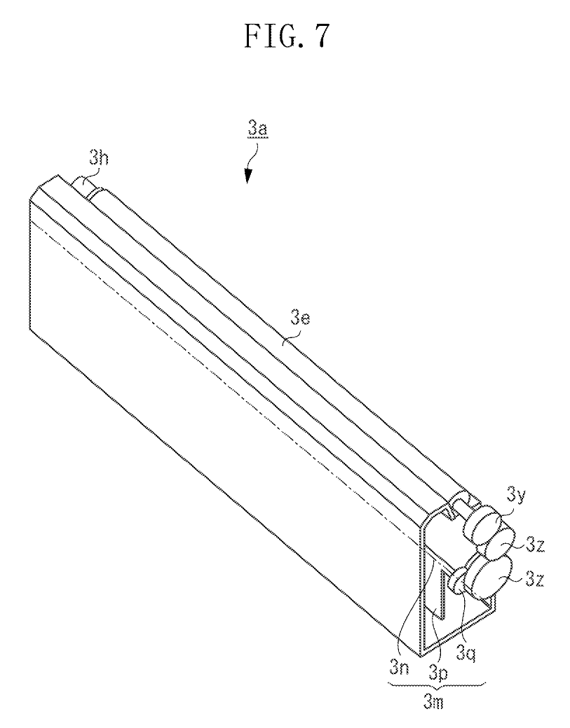

The stirring member 3m is arranged inside the toner container 3f for storing the toner and stirs the toner in the toner container 3f to supply the same to the developing roller 3e. As illustrated in FIG. 7, the stirring member 3m includes a stirring shaft 3n, a stirring sheet 3p mounted to the stirring shaft 3n, and a stirring drive gear 3q provided at an end portion of the stirring shaft 3n.

As illustrated in FIGS. 3 and 4, a coupling 3h is provided at an end portion of the developing roller 3e. The coupling 3h is connected with a coupling 11a on the image forming apparatus 10 main body side, so that the driving force from the motor 11 of the image forming apparatus main body can be transmitted to the developing roller 3e. In addition, a coupling 3k is provided at an end portion of the photosensitive drum 3b. The coupling 3k is connected with a coupling 12a on the image forming apparatus main body side, so that the driving force from the motor 12 of the image forming apparatus main body can be transmitted to the photosensitive drum 3b.

As illustrated in FIG. 7, a transmission gear 3y is fixed to the end portion of the developing roller 3e on the side opposite to the side where the coupling 3h is provided. When the developing roller 3e rotates, the stirring drive gear 3q is rotated via a transmission gear 3Y and an idler gear 3z, thereby rotating the stirring member 3m.

As illustrated in FIG. 2, the toner container 3f includes the opening 3r, which is provided for supplying the toner to the developing roller 3e. When the stirring roller 3e rotates within the toner container 3f, the toner is stirred and supplied to the developing roller 3e.

As described above, the developing roller 3e and the stirring member 3m are driven by the motor 11 of the image forming apparatus main body, and the photosensitive drum 3b is driven by the motor 12 of the image forming apparatus main body.

The non-contact type nonvolatile memory 3α stores information about whether the process cartridge 3 is new. The memory 3α can wirelessly communicate with the CPU 101 of the image forming apparatus via an antenna (not illustrated) as an information transmission unit, which is provided to the memory 3α. When the process cartridge 3 is attached to the image forming apparatus main body, the CPU 101 reads and writes the information about whether the process cartridge is new stored in the memory 3α. In the way, the memory 3α and the CPU 101 provided in the image forming apparatus main body function as a new product detection device.

The detection device is not limited to the above-described one. For example, a fuse can be provided to the process cartridge, and is configured to rupture when an electric current flows therethrough after the attachment of a new process cartridge to the image forming apparatus main body. Thus, it is possible to determine whether the process cartridge is a new one according to whether an electric current flows through the circuit including the fuse.

Next, operations of the image forming apparatus 10 at the time of normal developing processing (at the time of image formation) will be described. As illustrated in FIGS. 3 and 4, when the motor 11 of the main body of the image forming apparatus 10 rotates in the direction indicated by an arrow, the coupling 11a rotates in the direction indicated by the arrow via the idler gear. When the motor 12 rotates in the direction indicated by the arrow, the coupling 12a rotates in the direction indicated by the arrow via the idler gear.

In a state in which the process cartridge 3 is attached to the main body of the image forming apparatus 10, the coupling 11a of the main body of the image forming apparatus 10 configured to be rotated through the rotation of the motor 11, and the coupling 3h provided at an end portion of the developing roller 3e, are connected with each other. Further, the coupling 12a of the main body of the image forming apparatus 10 configured to be rotated through the rotation of the motor 12, and the coupling 3k provided at an end portion of the photosensitive drum 3b, are connected with each other. When the couplings are connected with each other, the developing roller 3e rotates in the direction indicated by an arrow A in FIG. 2, and the photosensitive drum 3b rotates in the direction indicated by an arrow B.

As described above, the photosensitive drum 3b and the developing roller 3e are rotating while being in contact with each other. Assuming that a peripheral velocity of the photosensitive drum 3b during normal developing processing is Vb, and a peripheral velocity of the developing roller 3e is Ve, a peripheral velocity relationship therebetween is set to Vb<Ve, taking into account the fact that the image forming apparatus 10 is intended for formation of a high density image. Rotation speeds of the motor 11 and the motor 12 at the time are Re and Rb, respectively.

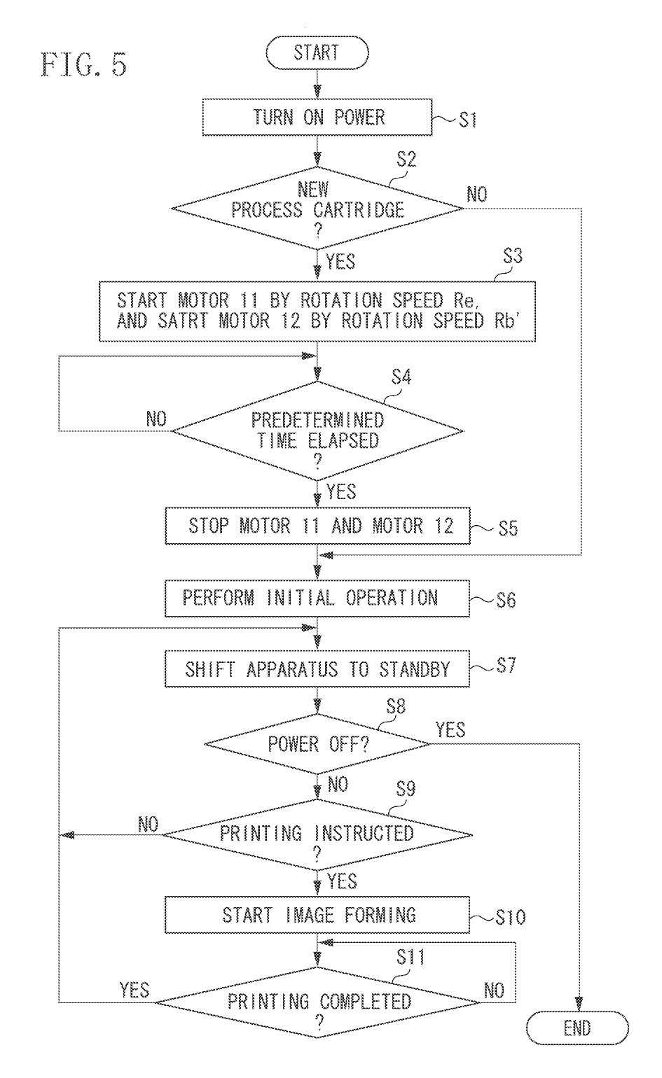

Next, operations of the image forming apparatus 10 when a new (unused) process cartridge 3 is attached will be described. An operational flow according to the present exemplary embodiment will be described with reference to the flowchart of FIG. 5, and the operation when a new process cartridge 3 is attached to the image forming apparatus 10 will be described. The processing is executed by the CPU 101.

In step S1, a power source of the main body is turned on, and then in step S2, the CPU 101 reads the information stored in the memory 3α by the wireless communication to determine whether the process cartridge 3 is new. In step S2, if it is determined that the process cartridge 3 is new (YES in step S2), in step S3, the CPU 101 starts the motor 11 at the rotation speed Re, and starts the motor 12 at a rotation speed Rb′, which is larger than the rotation speed Rb at the time of image formation. As a result, the photosensitive drum 3b rotates at a peripheral velocity Vb′, which is higher than the peripheral velocity Vb at the time of image formation.

By the rotational movement of the motor 11, drive is transmitted to the developing roller 3e and to the stirring member 3m. The developing roller 3e is driven at the peripheral velocity Ve, which is the same as that at the time of image formation. However, due to the rotational movement of the motor 12, the photosensitive drum 3b is rotating at the peripheral velocity Vb′, and since the rotation of the developing roller 3e is aided by the rotation of the photosensitive drum 3b, the load torque of the motor 11 is reduced.

In step S4, if it is determined that a predetermined period of time has elapsed since the start of the motor 11 and the motor 12 (YES in step S4), it is determined that an initial operation for placing the new process cartridge in a usable state is completed. Then in step S5, the rotation of the motor 11 and the motor 12 is stopped, thus the sequence for the new process cartridge 3 is ended.

Then in step S6, the main body of the image forming apparatus 10 performs an initial operation for receiving a print instruction. In step S7, the image forming apparatus 10 shifts to a standby state.

In this state, if the power is not turned off (NO in step S8), and a print instruction is issued (YES in step S9), then in step S10, an image forming operation is started. The rotation speed of the motor 11 and that of the motor 12 at the time are rotation speeds causing the developing roller 3e and the photosensitive drum 3b to rotate at a peripheral velocity corresponding to the normal developing process, i.e., Re and Rb, respectively. In step S11, when the series of printing operations are completed (YES in step S11), the processing returns to step S7, and the image forming apparatus shifts to the standby state again.

In one embodiment, the above-described predetermined time period (time for the CPU 101 to recognize that a new process cartridge 3 is attached to the image forming apparatus 10 and to rotate the motor 12 at the rotation speed Rb′) is a time period allowing the stirring member 3m to make one rotation or more in the toner container 3f. In the present exemplary embodiment, it is approximately ten seconds.

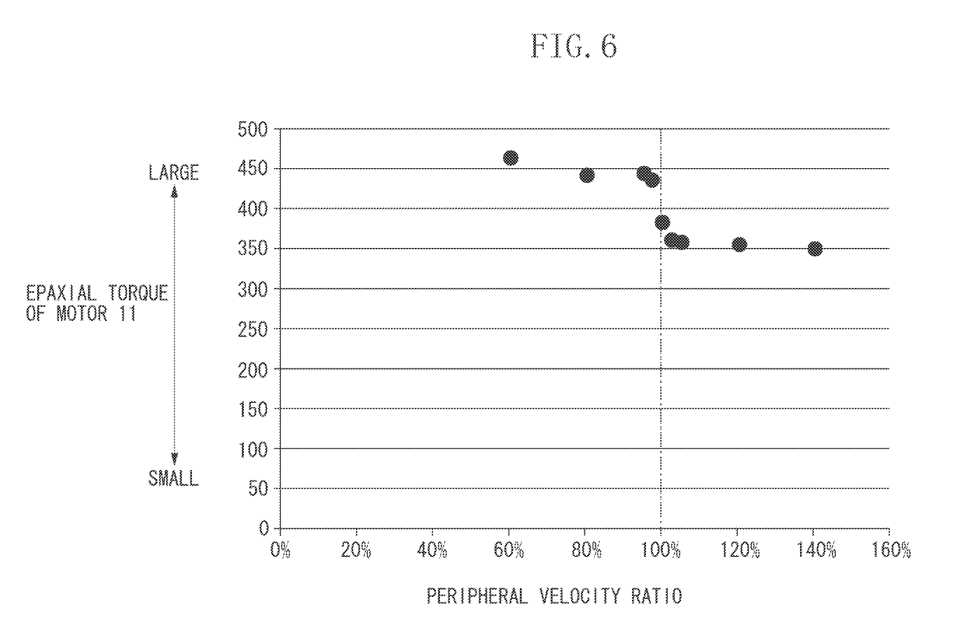

Referring to FIG. 6, a load torque reduction effect utilized in the present exemplary embodiment will be described. FIG. 6 illustrates changes in the torque used for driving the developing roller 3e when the peripheral velocity of the photosensitive drum 3b is changed, with the peripheral velocity of the developing roller 3e being kept constant. A horizontal axis indicates a peripheral velocity ratio (a ratio of the peripheral velocity of the photosensitive drum 3d to the peripheral velocity of the developing roller 3e), and a vertical axis indicates epaxial torque of the motor 11.

As can be seen from FIG. 6, the larger the peripheral velocity ratio, i.e., the higher the peripheral velocity of the photosensitive drum 3b, the lower the load torque of the motor 11. When the peripheral velocity ratio exceeds 100%, the reduction effect is further enhanced. In the way, by aiding the rotation of the developing roller 3e with the rotation of the photosensitive drum 3b, it is possible to reduce the load torque of the motor 11.

When the peripheral velocity of the photosensitive drum 3b is made higher than that at the time of image formation in order to aid the rotation of the developing roller 3e, the load torque of the motor 11 can be reduced, whereas the load torque of the motor 12 increases accordingly. However, the specification of the torque of the motor 12 for driving the photosensitive drum 3b is selected on the assumption of a state of the process cartridge 3 in the last stage of the service life, and, when the process cartridge is new, there is an adequate margin for the torque specification, so that it is possible to utilize the margin.

The reason for selecting the torque specification of the motor 12 on the assumption of the state of the process cartridge 3 in the last stage of the service life is that as the accumulated rotational time of the photosensitive drum 3b increases, influences of each of the processes (of which an influence of the wear and flaws of the photosensitive drum surface as a result of its being rubbed against the cleaning blade is expected to be particular significance) are accumulated on the surface of the photosensitive drum, and the torque used for driving the photosensitive drum 3b tends to increase.

Accordingly, when the initial driving of the stirring member is performed prior to image formation, the load torque of the motor 11 can be reduced by utilizing the specification margin of the motor 12, so that increase in the specification of the motor 11 can be suppressed with a simple configuration. Further, when the initial driving of the stirring member is performed prior to image formation, there is no need to reduce the rotational speed of the motor 11 than the image forming speed, so that increase in waiting time for the user can be suppressed. Further, when the peripheral velocities are set to Vb′>Ve, the load torque of the motor 11 can be reduced more effectively.

As described above, if the process cartridge 3 is new, the photosensitive drum 3b is driven at a speed higher than that during image formation at the time of performing the initial driving of the stirring member prior to the initial image formation. Accordingly, the coagulated state of the toner can be eliminated with a simple configuration while suppressing increase in the waiting time of the user until image formation starts.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-188960 filed Aug. 31, 2011, which is hereby incorporated by reference herein in its entirety.

What is claimed is:

1. An image forming apparatus comprising:
a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container;
a first driving device configured to drive the developer carrying member and the stirring member;
a second driving device configured to drive the image bearing member; and
a control unit configured to drive the developer carrying member and the stirring member by the first driving device and to execute an operation for driving the image bearing member by the second driving device at a peripheral velocity higher than that at a time of image formation before image formation is first performed by using a new process cartridge.

2. The image forming apparatus according to claim 1, wherein the control unit drives the image bearing member at a peripheral velocity higher than that of the developer carrying member in the operation.

3. The image forming apparatus according to claim 2, wherein the control unit drives the developer carrying member at a peripheral velocity higher than that of the image bearing member at the time of image formation.

4. The image forming apparatus according to claim 1, wherein the control unit drives the stirring member by one rotation or more in the operation.

5. The image forming apparatus according to claim 1, wherein the image forming apparatus includes a plurality of the process cartridges to form a color image, and
wherein the control unit executes the operation on the plurality of the process cartridges.

6. An image forming apparatus comprising:
a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container;
a first driving device configured to drive the developer carrying member and the stirring member;
a second driving device configured to drive the image bearing member; and
a detection device configured to detect whether the process cartridge is a new one; and
a control unit configured to drive the developer carrying member and the stirring member by the first driving device and to execute an operation for driving the image bearing member by the second driving device at a peripheral velocity higher than that at a time of image formation in response to that the process cartridge is detected as a new one by the detection device.

7. The image forming apparatus according to claim 6, wherein the control unit drives the image bearing member at a peripheral velocity higher than that of the developer carrying member in the operation.

8. The image forming apparatus according to claim 7, wherein the control unit drives the developer carrying member at a peripheral velocity higher than that of the image bearing member at the time of image formation.

9. The image forming apparatus according to claim 6, wherein the control unit drives the stirring member by one rotation or more in the operation.

10. The image forming apparatus according to claim 6, wherein the image forming apparatus includes a plurality of the process cartridges to form a color image, and
wherein the control unit executes the operation on the plurality of the process cartridges.

11. An image forming apparatus comprising:
a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container;
a first driving device configured to drive the developer carrying member and the stirring member;
a second driving device configured to drive the image bearing member; and
a control unit configured to drive the developer carrying member and the stirring member by the first driving device and to execute an operation for driving the image bearing member by the second driving device at a peripheral velocity higher than that of the developer carrying member before image formation is first performed by using a new process cartridge.

12. The image forming apparatus according to claim 11, wherein the control unit drives the developer carrying member at a peripheral velocity higher than that of the image bearing member at the time of image formation.

13. The image forming apparatus according to claim 11, wherein the image forming apparatus includes a plurality of the process cartridges to form a color image, and
wherein the control unit executes the operation on the plurality of the process cartridges.

14. An image forming apparatus comprising:
a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container;
a first driving device configured to drive the developer carrying member and the stirring member;
a second driving device configured to drive the image bearing member; and
a control unit configured to execute an operation for driving the image bearing member by the second driving device at a peripheral velocity higher than that at a time of image formation when the first driving device starts driving of the developer carrying member and the stirring member.

15. An image forming apparatus comprising:
a process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container;
a first driving device configured to drive the developer carrying member and the stirring member;
a second driving device configured to drive the image bearing member; and
a control unit configured to execute an operation for driving the image bearing member by the second driving device at a peripheral velocity higher than that of the developer carrying member when the first driving device starts driving of the developer carrying member and the stirring member.

16. The image forming apparatus according to claim 14, wherein the control unit drives the developer carrying member at a peripheral velocity higher than that of the image bearing member at the time of image formation.

17. The image forming apparatus according to claim 14, wherein the image forming apparatus includes a plurality of the process cartridges to form a color image, and
wherein the control unit executes the operation on the plurality of the process cartridges.

18. An image forming apparatus on which a process cartridge is detachably mounted, the process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container, the image forming apparatus comprising:
a first driving device configured to drive the developer carrying member and the stirring member;
a second driving device configured to drive the image bearing member; and
a control unit configured to drive the developer carrying member and the stirring member by the first driving device and to execute an operation for driving the image bearing member by the second driving device at a peripheral velocity higher than that at a time of image formation before image formation is first performed by using a new process cartridge.

19. An image forming apparatus on which a process cartridge is detachably mounted, the process cartridge including an image bearing member configured to bear an electrostatic latent image, a toner container configured to store a toner, a developer carrying member configured to rotate while being in contact with the image bearing member to develop the electrostatic latent image with the toner, and a stirring member configured to stir the toner within the toner container, the image forming apparatus comprising:
a first driving device configured to drive the developer carrying member and the stirring member;
a second driving device configured to drive the image bearing member; and
a control unit configured to drive the developer carrying member and the stirring member by the first driving device and to execute an operation for driving the image bearing member by the second driving device at a peripheral velocity higher than that of the developer carrying member before image formation is first performed by using a new process cartridge.

20. The image forming apparatus according to claim 19, wherein the control unit drives the developer carrying member at a peripheral velocity higher than that of the image bearing member at the time of image formation.
